(19) United States
(12) Patent Application Publication
(10) Pub. No.: US 2014/0035455 A1
(43) Pub. Date: Feb. 6, 2014

(54) LED Lamp With A High Color Rendering Index

(71) Applicants: Miguel Galvez, Danvers, MA (US); David Betts, Peabody, MA (US); Mary Ann Johnson, Rockport, MA (US)

(72) Inventors: Miguel Galvez, Danvers, MA (US); David Betts, Peabody, MA (US); Mary Ann Johnson, Rockport, MA (US)

(73) Assignee: OSRAM SYLVANIA INC., Danvers, MA (US)

(21) Appl. No.: 13/562,893

(22) Filed: Jul. 31, 2012

(51) Int. Cl. H05B 33/12

(52) U.S. Cl. 313/498

(57) ABSTRACT

LED lamps having a high color rendering index are disclosed. In some embodiments, such lamps also exhibit high lumen maintenance and low color drift during lamp warm-up. The lamps may include, for example, a light emitting diode (LED) kernel having a mixture of red and blue LEDs, and a converter including a red phosphor in an amount ranging from greater than 0 to about 10 weight % of a total phosphor content of the converter.

### FIELD OF THE INVENTION

The present application relates to light sources with a high color rendering index (CRI) and, more particularly, to light emitting diode (LED) lamps with a high color rendering index.

### BACKGROUND OF THE INVENTION

Solid state light sources such as light emitting diodes (LEDs) generate visible or non-visible light in a specific region of the electromagnetic spectrum. An LED may output light, for example, in the blue, red, green or non-visible ultra-violet (UV) or near-UV regions of the electromagnetic spectrum, depending on the material composition of the LED. When it is desired to construct an LED light source that produces a color different from the output color of the LED, it is known to convert the LED light output having a peak wavelength (“primary light”) to light having a different peak wavelength (“secondary light”) using photoluminescence.

Photoluminescence generally involves absorbing higher energy primary light by a converter including a wavelength converting material (“conversion material”) such as a phosphor or mixture of phosphors. This absorption excites the conversion material to a higher energy state. When the conversion material returns to a lower energy state, it emits secondary light, generally of a longer wavelength than the primary light. The peak wavelength of the secondary light depends on the type of phosphor material. This process may be generally referred to as “wavelength conversion.” An LED combined with a converter that includes a conversion material such as phosphor to produce secondary light may be described as a “phosphor-converted LED” or “wavelength converted LED.” This is particularly the case for white LEDs in which a phosphor or mixture of phosphors is used to produce a white light having a desired correlated color temperature (CCT) and/or color rendering index (CRI).

In a known configuration, an LED die such as a group III nitride die is positioned in a reflector cup package. To convert primary light to secondary light, a converter may be provided. The converter structure may take the form of a self supporting “plate” such as a ceramic plate or a single crystal plate, a dome, a thin film, or some other form. The converter may be attached directly to the LED, e.g. by wafer bonding, sintering, gluing, etc., or the converter may comprise phosphor particles dispersed in a transparent resin which directly encapsulates the LED die. Such a configuration may be understood as “chip level conversion” or “CLC.” Alternatively, the converter may be positioned remotely from the LED. Such a configuration may be understood as “remote conversion.”

Interest has grown in phosphor converted white LED lamps having a high (≧90) color rendering index (CRI). Although several known phosphor converted white LED lamps with high CRI exist, these existing solutions may exhibit significant color shift, poor lumen maintenance and/or require the use of complex driving circuitry. Such issues may limit the usefulness and commercial viability of such lamps.

### BRIEF DESCRIPTION OF THE DRAWINGS

Reference should be made to the following detailed description which should be read in conjunction with the following figures:

FIGS. 1A and 1B diagrammatically illustrate exemplary light sources including a converter positioned for chip level conversion or remote conversion, respectively, in accordance with the present disclosure.

FIG. 2 diagrammatically illustrates a prior art LED kernel for use in a full white phosphor configuration.

FIG. 3 diagrammatically illustrates a prior art LED kernel for use in a high red LED configuration.

FIG. 4 diagrammatically illustrates an exemplary LED kernel in accordance with the present disclosure.

FIG. 5 is a plot of spectral power distribution for exemplary lamps having a full white phosphor configuration, a high red LED configuration, and a configuration in accordance with the present disclosure.

FIG. 6. is a plot of color drift versus time for exemplary lamps having a full white phosphor configuration, a high red LED configuration, and a configuration in accordance with the present disclosure.

FIG. 7 is a plot of lumen maintenance versus time for exemplary lamps having a full white phosphor configuration, a high red LED configuration, and a configuration in accordance with the present disclosure.

### DETAILED DESCRIPTION

As used herein, the terms “about” and “substantially,” when used in connection with a numerical value or range, mean+/−5% of the recited numerical value or range.

From time to time, one or more aspects of the present disclosure may be described using a numerical range. Unless otherwise indicated herein, any recited range should be interpreted as including any iterative values between indicated endpoints, as if such iterative values were expressly recited. Such ranges should also be interpreted as including any and all ranges falling within or between such iterative values and/or recited endpoints, as if such ranges were expressly recited herein.

The terms “chromaticity coordinates,” “color coordinates,” or “chromaticity data” are interchangeably used herein to refer to numerical information correlating to the CIE color space created by the International Commission on Illumination (CIE). The same reference applies with respect to the Cx, Cy coordinates specified herein.

One aspect of the present disclosure relates to lamps, including phosphor converted white LED lamps, having a high color rendering index (“CRT”). The terms, “high CRT” and “high color rendering index” are interchangeably used herein to mean a CRT that is greater than or equal to about 90. CRT may be understood as a quantitative measure of a light source's ability to accurately reproduce colors of an object, in comparison to a reference light source of the same CCT, generally a black body radiator for a CCT below 5000K. CRT may range from 0 to 100, with a rating of 100 indicating that a lamp is capable of reproducing colors of an object in the same way as a reference light source. Also, as may be understood in the art, “R9 value” refers to a specific color rendering index that evaluates the ability of a lamp to produce colors in the red region of the electromagnetic spectrum.

The terms “warm-up” and “lamp warm-up” are interchangeably used herein to refer to the time period between the initial powering of the light source and the first twenty minutes of operation of the light source.

References to the color of a phosphor, LED or conversion material refer generally to its emission color unless otherwise specified. Thus, a blue LED emits a blue light, a yellow phosphor emits a yellow light and so on.

An LED “die” (also referred to as an LED “chip”) is an LED in its most basic form, i.e., in the form of the small individual pieces produced by dicing the much larger wafer onto which the semiconducting layers were deposited. The LED die can include contacts suitable for the application of electric power. An LED die may be mounted in an LED package (also referred to as a module) which may also include other conventional elements such as a silicone encapsulant, optically active components (lenses, reflective sides), a lead frame, and heat dissipating elements.

The terms LED package, LED module, LED die etc. may be generally referred to herein by the broader term LED.

The terms “LED lamp” and “LED light source” are interchangeably used herein to generally refer to a device that emits light using a configuration of one or more light emitting diodes (LEDs). An LED lamp or LED light source may include other components such as a mounting structure, housing, heatsink, electrical connectors, power supply, or other electrical or optical elements.

The term “LED kernel” as used herein refers only to an arrangement or array of LEDs (or LED dies). The number and distribution of LEDs in the LED kernels described herein may vary widely. For example, the LED kernels described herein may include just a few LEDs to 100 LEDs or more. With respect to the present invention, the LEDs (or LED dies) used in the LED kernel of the present invention do not use phosphor conversion to generate their primary red or blue emissions. However, the LED kernel as described herein is coupled with a phosphor converter element to generate the final white light emission from the LED lamp.

As used herein, the weight percentages of a phosphor are with reference to the total phosphor content of a phosphor converter and not the total weight of the converter itself which may include other materials such as an epoxy or silicone resin or non-luminescent scattering particles.

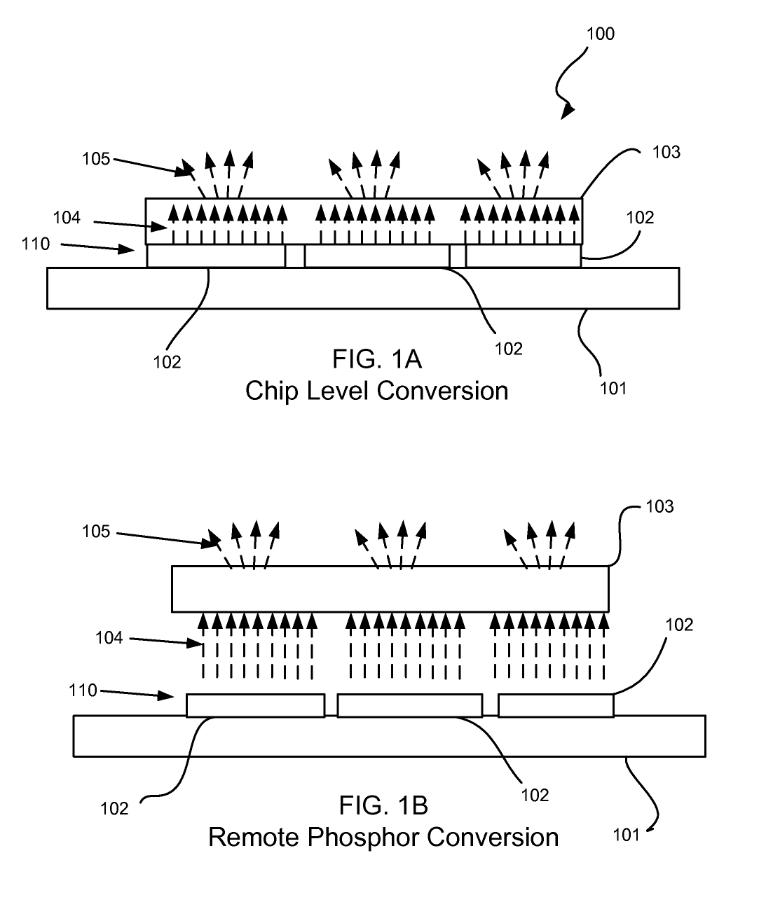

FIGS. 1A and 1B diagrammatically illustrate the structure of two exemplary configurations that may be employed in the LED light source of this invention. In FIG. 1A, lamp 100 includes LED dies 102 on support 101. The arrangement of LED dies 102 comprises LED kernel 110. Converter 103 is disposed on a light emitting surface (not labeled) of LED dies 102. At least a portion of primary light 104 emitted from LED dies 102 may be incident on and absorbed by converter 103. The absorption of primary light may excite conversion material within converter 103 to a higher energy state. When the conversion material relaxes to a lower energy state, converter 103 may emit secondary light 105. Because converter 103 abuts a surface of LED dies 102, lamp 100 in FIG. 1A may be understood to have a “chip level conversion” (CLC) structure. The converter 103 may comprised a solid sintered ceramic or an optically transparent resin such as a silicone in which phosphor particles are embedded.

FIG. 1B includes the same elements as FIG. 1A, and thus the nature and function of such elements will not be repeated. Unlike FIG. 1A, however, converter 103 in FIG. 1B is placed some distance away from the light emitting surface of LED dies 102. Because converter 103 is “remote” from LED dies 102, FIG. 1B may be understood as depicting an LED lamp configuration having a “remote phosphor” configuration. Also, since the converter 103 is remote from the surfaces of LED dies 102, it is also possible in this configuration to use LED packages in place of the LED dies.

In the interest of clarity and for ease of understanding, FIGS. 1A and 1B depict the structure of lamp 100 in simplified form. It should be understood that lamp 100 may include any of the various other components that may be included in a lamp. Such components may include, for example, driving electronics, one or more reflectors, a housing, one or more heat sinks, one or more diffusers, combinations thereof, and the like.

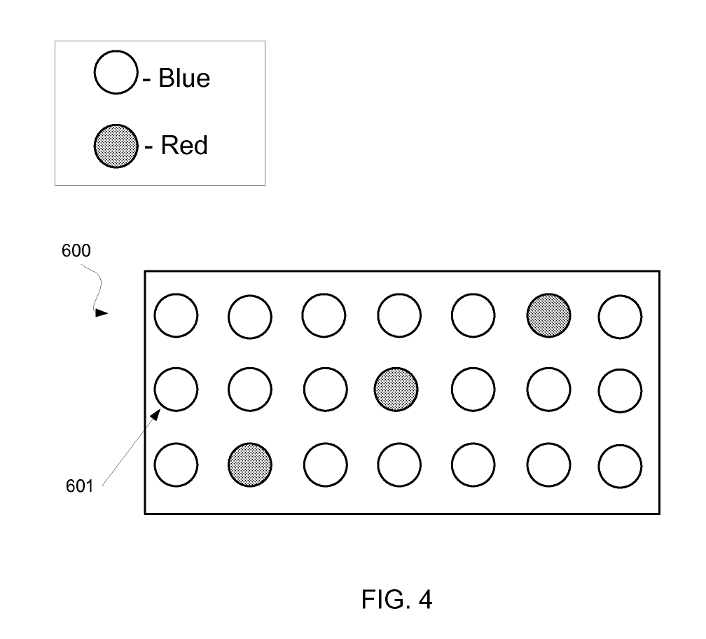

As described above, LED dies 102 emit a primary light 104 from a light emitting surface thereof. With respect to the present invention, an LED kernel will include a combination of blue LEDs and red LEDs (more specifically, blue and red LED dies or packages), i.e., LEDs that emit a peak wavelength in the blue and red regions, respectively, of the electromagnetic spectrum without phosphor conversion. As will be described later in connection with FIG. 4, the LED kernels described herein may be configured to provide primary light with a desired spectral power distribution, even when powered by a single electronic circuit.

While FIGS. 1A and 1B depict converter 103 as a flat structure such as a plate, such configuration should be considered exemplary only. Indeed, converters of any form or shape may be used in accordance with the present disclosure. For example, converter 103 may take the form of one or more plates, thin films, domes, other structures, and/or combinations thereof. In some embodiments, converter 103 is a phosphor dome positioned remotely from LED dies 102.

As noted previously, phosphor converted white LED lamps with a high CRI are known. However, the known configurations of these lamps can exhibit various problems, which may limit their usefulness and/or commercial viability. For the sake of clarity, the present disclosure will now discuss the configuration and performance of two known white LED lights sources that are capable of exhibiting a high CRI. The construction and performance of exemplary light sources in accordance with the present disclosure will be subsequently discussed.

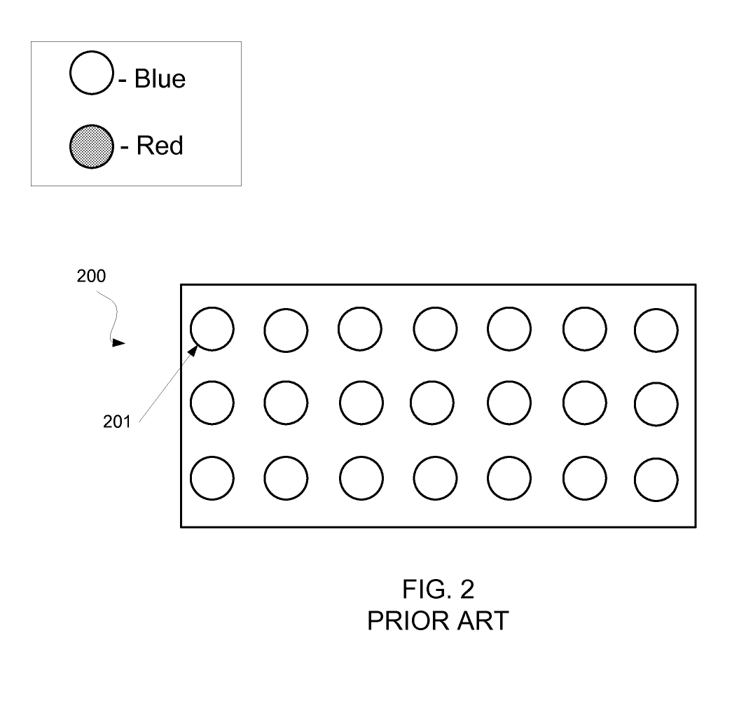

In a first known configuration (hereafter, the “full white phosphor configuration” or “full white phosphor lamp”), a white LED light source exhibiting a high CRI is formed using an LED kernel that includes only blue LEDs. As an illustration of such a kernel, reference is made to FIG. 2, wherein LED kernel 200 includes multiple (twenty one) blue LEDs 201 arranged in a pattern on an underlying support (not labeled). In operation, blue LEDs 201 of LED kernel 200 emit blue primary light that impinges on a converter, such as a phosphor dome. The converter in the full white phosphor configuration includes a blend of red, green, and yellow phosphors, which act to convert incident blue primary light to white secondary light.

Because LED kernel 200 in the full white phosphor configuration only includes blue LEDs, the blue primary light incident on the converter may exhibit chromaticity coordinates that are significantly different from the chromaticity coordinates of a black body radiator. To adjust the chromaticity coordinates of the light source back to the black body, the phosphor blend in the converter is formulated to include a significant amount of red phosphor. For example, the phosphor blend may include 16-30 weight % of red phosphor, or more. The resultant combination of blue LED kernel 200 and the phosphor blend can in some instances form a lamp with a high CRI, e.g., a CRI of 92 and an R9 value of 75.

Although high CRI may be achieved with a full white phosphor lamp, such lamps rely on the use of a converter that includes large amounts (e.g., greater than or equal to about 16 weight %) of red phosphor to convert at least a portion of the blue primary light from the LED kernel to red secondary light. This can present several problems. First, the large amount of red phosphor can lead to increased lamp temperature, particularly during warm-up. As the temperature of the lamp increases, thermal quenching of the red phosphor in the converter may occur. As a result, full white phosphor lamps may exhibit significant color shift and lumen depreciation (i.e., reduced lamp efficiency). Such color shift may be particularly apparent in type A and PAR (parabolic aluminized reflector) lamps.

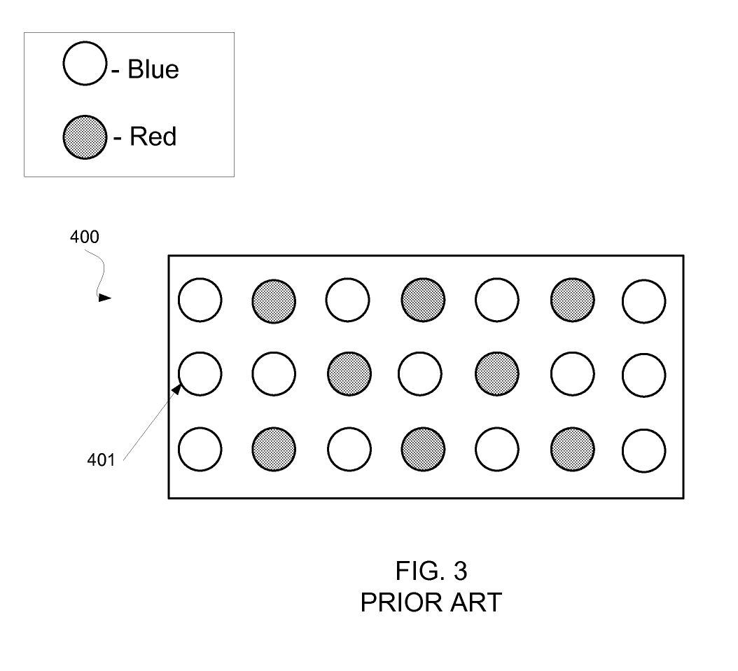

In a second known configuration (hereafter, the “high red LED configuration” or a “high red LED lamp”), a white LED lamp exhibiting a high CRI may be formed using an LED kernel that includes a combination of blue LEDs and red LEDs, wherein the red to blue LED ratio is greater than or equal to about 0.6. As one example of such an LED kernel, reference is made to FIG. 3. As shown, LED kernel 400 includes multiple (e.g., twenty one) LEDs 401 arranged in a pattern on an underlying support (not labeled). Unlike the LED kernel of the full white phosphor lamp described above, LEDs 401 include a combination of red (shaded) and blue (unshaded) LEDs. For the sake of illustration, FIG. 3 depicts LED kernel 400 as including 8 red LEDs and 13 blue LEDs. Thus, the ratio of red to blue LEDs in FIG. 3 is approximately 0.61.

In operation, LEDs 401 of LED kernel 400 emit primary light in the blue and red regions of the electromagnetic spectrum. At least a portion of the primary light emitted by LEDs 401 impinges on a converter such as a phosphor dome (not shown). Unlike the full white phosphor lamp, the converter in a high red LED lamp only includes a green-yellow phosphor. During operation of the lamp, the phosphor in the converter absorbs at least a portion of the blue primary light emitted by the LED kernel and converts it to green-yellow secondary light.

To evaluate the optical performance of this configuration, an exemplary high red LED lamp was constructed and measured. The measured high red LED lamp included an LED kernel with blue and red LEDs, and a converter in the form of a hemispherical remote phosphor shell. The converter was made of silicone mixed with a green-yellow phosphor, (Ca,Sr)Si₂O₂N₂:Eu. The dome of the converter was 0.5 mm thick and had a 1 inch inner diameter. Of course, the tested high red LED lamp is exemplary only, and high red LED lamps having other configurations and dimensions are possible. It should be understood, however, that the dimensions of the LED kernel and the converter do not modify the issues described herein with respect to high red LED lamps.

The chromaticity and spectral power data were measured when the blue LEDs in LED kernel 400 were powered at 350 milliamps (mA) and the red LEDs in LED kernel 400 were not powered. The Cx, Cy chromaticity coordinates (0.376, 0.4501) of the lamp in this operating condition are significantly above those of a reference black body radiator. Without wishing to be bound by theory, it is believed that the high chromaticity coordinates are due to the green-yellow phosphor converter used in the high red LED lamp. In any case, the measured lamp exhibited a low CRI of 64, and an R9 value of −71 under this operating condition. The bluish/greenish (CCT of 4503K) hue of light emitted by the measured lamp in this operating condition was highlighted in the corresponding spectral power data, which showed a relatively high ratio of blue to red light power.

The chromaticity and spectral power data for the high red LED lamp were measured again when the blue and red LEDs in LED kernel 400 were both powered at 350 mA. The data showed that the red LEDs provide too much red light under this operating condition, causing the chromaticity coordinates of the light source to fall below those of the reference black body (CRI of 81). The reddish hue (CCT of 1941K) of this lamp was further demonstrated in the corresponding spectral power data, which showed a relatively high ratio of red:blue light power.

The chromaticity and spectral power data for the high red LED lamp were further measured, when the red and blue LEDs were driven at different power levels. Specifically, the red LEDs were driven by a first electrical circuit at 150 mA, and the blue LEDs were driven by a second electrical circuit at 350 mA. Under these conditions, the chromaticity coordinates of the light source were in line with those of a reference black body radiator (CRI of 92), and the lamp exhibited a warm color temperature of 2722K.

This demonstrates that the measured high red LED lamp can achieve a high CRI. To achieve that performance, however, two electrical circuits were needed to drive the red and blue LEDs at different power levels. This can increase the complexity and/or cost of the lamp circuitry. In addition, the red LEDs being comprised of a different material than the blue LEDs can become less efficient during lamp warm-up, leading to a strong shift towards cold color temperatures, i.e., to high CCT values. While the color shift maybe addressed using a temperature sensor that dynamically adjusts the power supplied to the blue and red LEDs, such a solution can further increase the cost and complexity of the already complex lamp circuitry.

Having discussed known wavelength converted white LED lamp configurations, the specification will now discuss wavelength converted LED lamps in accordance with the present disclosure. As will be described in detail below, the LED lamps of the present disclosure may address or otherwise overcome one or more of the disadvantages of the full white phosphor configuration and/or the high red LED configuration.

As explained above with reference to FIGS. 1A and 1B, the lamps of the present disclosure may generally be of a chip level conversion or remote conversion structure. That is, the lamps may have a wavelength conversion structure (converter) such as a plate, a thin film, a dome, or the like, which abuts or is remote from the light emitting surface(s) of an LED kernel. In any case, the converter may be configured to convert at least a portion of primary light emitted by the LED kernel to secondary light.

FIG. 4 illustrates a non-limiting example of an LED kernel that may be used in accordance with the lamps of the present disclosure. As shown, LED kernel 600 includes a plurality of LEDs 601 arranged in a pattern on an underlying support (not labeled). For the sake of illustration, LED kernel 600 is depicted as including 21 LEDs 601, of which 18 are blue (unshaded), and 3 are red (shaded). Of course, LED kernel 600 may include any number of LEDs (individually as LED dies or mounted in a package configuration), and such LEDs may be arranged in any desired configuration. Moreover, the placement of the red LEDs in FIG. 4 should be considered exemplary only.

Any LED having peak emission in the 420-490 nanometer (nm) range of the electromagnetic spectrum may be used as the blue LEDs in FIG. 4. As non-limiting examples of suitable blue LEDs, mention is made of gallium nitride (GaN), indium gallium nitride (InGaN) LEDs, combinations thereof, and the like.

With respect to the red LEDs in FIG. 4, any LED having peak emission in the 600-710 nm range of the electromagnetic spectrum may be used. As non-limiting examples of suitable red LEDs, mention is made of aluminum gallium arsenide (AlGaAs) LEDs, gallium arsenide phosphide (GaAsP) LEDs, aluminum gallium indium phosphide (AlGaInP) LEDs, and gallium (III) phosphide (GaP) LEDs, combinations thereof, and the like.

LED kernel 600 may be configured so as to provide primary light having a desired amount of red and blue light. For example, LED kernel 600 may be configured so as to provide primary light having a desired amount of red light power and blue light power. For example, LED kernel 600 may provide primary light having a red light power ranging from about 100 to about 740 milliWatts (mW). In some embodiments, LED kernel 600 provides primary light having a red light power ranging from about 100 to about 500 mW, about 125 to about 400 mW, about 150 to about 350 mW, about 200 to about 300 mW, or even about 200 to about 250 mW.

Likewise, LED kernel 600 may be configured to provide primary light having a blue light power ranging from about 1 to about 16 Watts (W). In some embodiments, LED kernel 600 provides primary light having a blue light power ranging from about 1 to about 10 W, about 1 to about 5 W, about 1.5 to about 4 W, such as about 2 to about 3.5 W, or even about 2.5 to about 3 W.

LED kernel 600 may also be configured to provide primary light a desired ratio of red to blue light power. For example, LED kernel may provide primary light having a ratio of red to blue LED power ranging from about 0.025 to about 0.2, such as about 0.05 to about 0.1, or even about 0.07 to about 0.085. In some embodiments, LED kernel 600 is configured to provide red light with a spectral power of 250 mW, and blue light with a spectral power of 3 W. In such embodiments, the ratio of red to blue power may be about 0.083. In contrast, high red LED lamps may emit primary light having a ratio of red to blue light power of 0.3 or more.

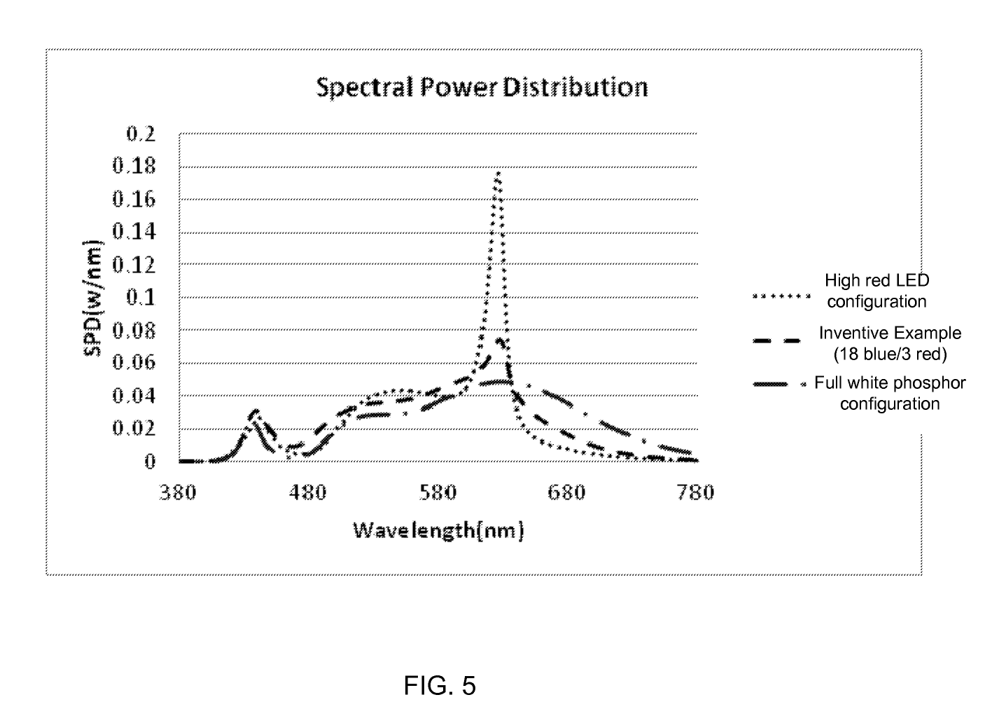

FIG. 5 provides a plot of spectral power data (SPD in watts/nm) measured from an exemplary LED lamp in accordance with the present disclosure (Inventive Example), as compared to a full white phosphor lamp and high red LED lamp. As shown, the spectrum of the high red LED lamp includes a strong emission peak in the red region at about 626 nm which was not exhibited by the measured full white phosphor lamp. While the lamp according to the present disclosure exhibited a similar emission peak in the red region, such peak was of lower intensity than the corresponding peak exhibited by the high red LED lamp.

The red and blue light content and/or power of the primary light may be adjusted by controlling the number of red and blue LEDs in LED kernel 600. In the lamps of the present disclosure, the ratio of red to blue LEDs in LED kernel 600 may be about 1 red:10 blue, such as about 1 red:9 blue, about 1 red:8 blue, about 1 red:7 blue, about 1 red:6 blue, about 1 red:5 blue, or even about 1 red:4 blue. By adjusting the number of red LEDs to blue LEDs, LED kernel 600 may provide primary light with the desired spectral characteristics, even when the red and blue LEDs are driven at the same power. As a result, the LED kernels of the present disclosure may be driven by a single electrical circuit. In some instances, this can simplify and/or reduce the cost of the lamp circuitry, particularly as compared to the circuitry used in a high red LED lamp.

The lamps of the present disclosure may utilize a wavelength converting structure that includes one or more phosphors to convert primary light to secondary light. In some embodiments, the conversion material includes a red phosphor, alone or in combination with other (e.g. green, yellow, orange, etc.) phosphors. Suitable red phosphors that may be used include those selected from europium-activated alkaline earth nitrodosilicate phosphors, (M)₂Si₅N₈:Eu where M is Ba, Ca, or Sr; in particular, Ca₂Si₅N₈:Eu, (Ca,Sr)₂Si₅N₈:Eu and (Ba,Sr)₂Si₅N₈:Eu, combinations thereof and the like. Suitable green phosphors that may be used include but are not limited to garnet phosphors such as (Lu,Ga)₃Al₅O₁₂:Ce, silicate phosphors such as Ca₈Mg(SiO₄)₄Cl₂:Eu and BaSi₂O₂N₂:Eu and combinations thereof, and the like. Suitable yellow phosphors that may be used include garnet phosphors such as yttrium aluminum garnet doped with one or more rare earth elements such as cerium, Y₃Al₅O₁₂:Ce (YAG:Ce).

Of course, the above noted phosphors should be considered exemplary only, and other phosphors may be used in the converters in accordance with the present disclosure. Table 1 below provides ranges of chromaticity coordinates for various phosphors that may be used in accordance with the present disclosure.

TABLE 1
Chromaticity Coordinates for Exemplary Suitable Phosphors.

| Phosphor Color | Cx, Cy Chromaticity Coordinate Range |
|---|---|
| Yellow | From about (0.450, 0.515) to about (0.473, 0.530) |
| Green | From about (0.187, 0.589) to about (0.359, 0.604) |
| Orange | From about (0.556, 0.411) to about (0.5853, 0.435) |
| Red | From about (0.611, 0.342) to about (0.655, 0.386) |

As non-limiting examples of phosphors that are within the chromaticity coordinates mentioned in Table 1, mention is made of yellow (Y,Gd)₃Al₅O₁₂:Ce phosphors, green (Lu,Ga)₃Al₅O₁₂:Ce phosphors, and orange to red emitting phosphors from the group of nitrodosilicate phosphors represented by (M)₂Si₅N₈:Eu where M is Ba, Ca, or Sr.

The amount of red phosphor in the converters used in the lamps according to the present disclosure may range from greater than 0 to about 10 weight % of the total weight of the phosphors in the converter. In some embodiments, the amount of red phosphor ranges from about 1 to about 9 weight %, about 2 to about 8 weight %, about 3 to about 7 weight %, or even about 4 to about 6 weight % of the total weight of phosphors in the converter. In contrast, a converter used in a lamp of a full white phosphor configuration may contain 16 weight % or more red phosphor. And in a high red LED configuration, no red phosphor is used in the converter.

Chromaticity data and spectral power data were measured for an exemplary remote phosphor shell used in a high red LED configuration and an exemplary remote phosphor shell in accordance with the present disclosure. Both converters were illuminated by primary light produced by blue LEDS. Both converters exhibited chromaticity coordinates above those of a reference black body curve. However, the chromaticity coordinates of the converter in accordance with the present disclosure were closer to the black body curve than those of the high red LED converter. Specifically, the converter according to the present disclosure exhibited Cx, Cy chromaticity coordinates of (0.3938, 0.4501) and a CCT of 3871K, whereas the converter of the high red LED configuration exhibited chromaticity coordinates of (0.376, 0.4501) and a CCT of 4503. Thus, relative to the high red LED lamp converter, less additional red light is needed to bring the chromaticity coordinates of the converters described herein into line with the chromaticity coordinates of the reference black body radiator.

From the above, it may be appreciated that the lamps of the present disclosure can utilize red primary light produced by an LED kernel and red secondary light produced by a phosphor converter to achieve chromaticity coordinates that closely approximate those of a reference black body radiator, and hence, high CRI. With this in mind, the amount of red light supplied by the LED kernel and the converter may be adjusted relative to one another, while still achieving high CRI. That is, the amount of red primary light supplied by the LED kernel may be raised or lowered by increasing and decreasing, respectively, the number of red LEDs that are used. Likewise, the converter may be configured to provide more or less red secondary light by increasing and decreasing, respectively, the amount of red phosphor in the converter. As the amount of red primary light increases (i.e., the LED kernel includes more red LEDs), less red phosphor is needed in the converter to adjust the chromaticity coordinates of the lamp to a reference black body. Likewise, as the amount of red primary light decreases (e.g., by lowering the number of red LEDs in the LED kernel), more red phosphor needed in the converter to adjust the chromaticity coordinates of the lamp to a reference black body.

The LED kernels and converters of the present disclosure may therefore be formulated so as to provide a desired amount of red light. In some embodiments, the LED kernel includes a ratio of red to blue LEDs ranging from about 1:5 to about 1:8, and the converter includes a red phosphor in an amount ranging from about 3 to about 8 weight % of a total phosphor content of the converter. In further non-limiting embodiments, the ratio of red to blue LEDs in the LED kernel ranges from about 1:5 to about 1:7, and the converter includes a red phosphor in an amount ranging from about 4 to about 7 weight %. And in still further non-limiting embodiments, the ratio of red to blue LEDs in the LED kernel is about 1:6, and the converter includes a red phosphor in an amount ranging from about 5 to about 6.5 weight %.

The lamps according to the present disclosure may exhibit a CRI that is greater than or equal to about 90. In some embodiments, the lamps described herein exhibit a CRI of greater than about 90, about 93, about 95, or about 97.

In addition to high CRI, the lamps of the present disclosure may exhibit desirable color drift properties, particularly during lamp warm-up. In the context of the present disclosure, “color drift” means the difference in correlated color temperature (DCCT) exhibited by a lamp from initial powering of the lamp to 20 minutes of operation. With this in mind, the lamps of the present disclosure may exhibit a color drift (DCCT) of less than or equal to about 300K, such as less than or equal to about 250K, less than or equal to about 200K, less than or equal to about 175K, less than or equal to about 150K, less than or equal to about 125K, or even less than or equal to about 100K.

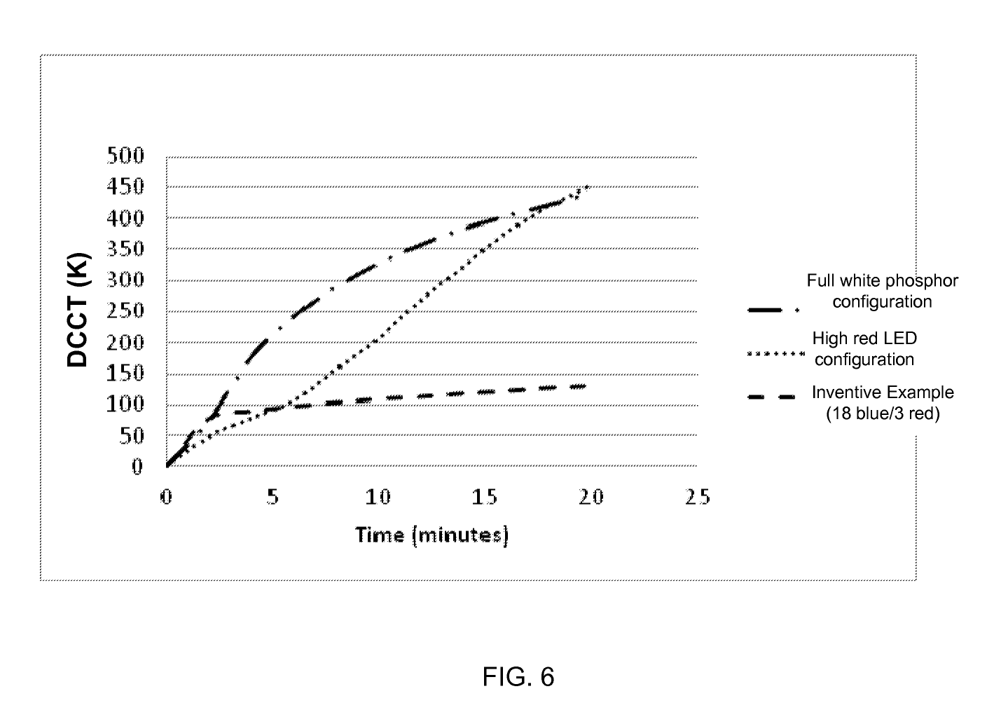

To evaluate color drift performance, a lamp in accordance with the present disclosure (Inventive Example), a high red LED lamp, and a full white phosphor lamp were constructed and placed in a respective integrated spheres. The measured lamps were the same configuration as those described above. The lamps were each powered at 350 milliamps by a direct current power source. Optical measurements of each lamp were taken at 2 minute intervals for 20 minutes. The difference in correlated color temperature (DCCT) for each lamp was determined, and is plotted in FIG. 6. The raw CCT, CRI and chromaticity coordinate data at 0 and 20 minutes for each lamp is provided below in Table 2.

TABLE 2
CCT, CRI and Chromaticity Data

| | | | | Chromaticity |
|---|---|---|---|---|
| Lamp Type | Time (Min) | CCT(K) | CRI | (Cx, Cy) |
| Full white Phosphor | 0 | 2857 | 92 | (0.4516, 0.4155) |
| Full white Phosphor | 20 | 3297 | 89 | (0.4073, 0.3726) |
| High red LED | 0 | 2056 | 83 | (0.5045, 0.3921) |
| High red LED | 20 | 2509 | 83 | (0.4675, 0.3992) |
| Inventive Example | 0 | 3174 | 93 | (0.4239, 0.3726) |
| Inventive Example | 20 | 3304 | 91 | (0.4139, 0.3891) |

As shown, the lamps of the present disclosure exhibited higher CRI and lower color drift than the prior art lamp configurations throughout lamp warm-up.

Alternatively or additionally, the lamps of the present disclosure may exhibit desirable lumen maintenance, particularly during lamp warm-up. As used herein, the term “lumen maintenance” refers to the depreciation (in percent) of lumens emitted by a lamp from initial powering to 20 minutes of operation (i.e., during lamp warm-up). Higher lumen maintenance indicates that a lamp maintains more of its lumen output over time, whereas lower lumen maintenance indicates that a lamp maintains less of its lumen output over time. A related property is lumen depreciation, which refers to the amount of lumen output (in percent) that is lost by a lamp, relative to the lumen output of the lamp at initial powering of the lamp. The lamps of the present disclosure may exhibit lumen maintenance from 0 to 20 minutes of greater than or equal to about 80, 85, 90, 95, 96, 97, 98, or even 99%. In other terms, the lamps of the present disclosure may exhibit lumen depreciation from 0 to 20 minutes of less than or equal to about 20, 15, 10, 5, 4, 3, 2, or even 1%.

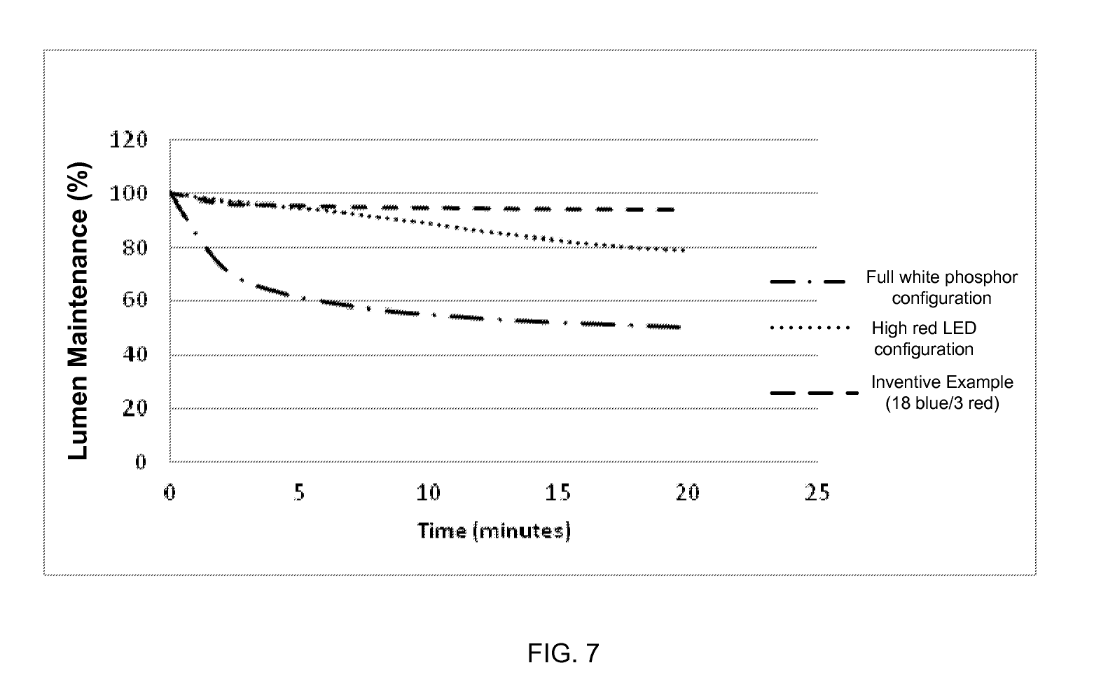

To evaluate lumen maintenance performance, a lamp in accordance with the present disclosure (Inventive Example), a high red LED lamp, and a full white phosphor lamp were constructed and placed in respective integrated spheres. The measured lamps were the same configuration as those described above. The lamps were each powered at 350 mA by a direct current power source. The lumen output of each lamp was measured in 2 minute increments for 20 minutes. The lumen depreciation of each lamp over this operating period was determined, and is plotted in FIG. 7. As shown, the lamp of the present disclosure exhibited lumen depreciation of about 5% after 20 minutes, whereas the high red LED lamp and the full white phosphor lamp exhibit lumen depreciation of about 20% and about 55% respectively.

According to one aspect of the present disclosure, an LED lamp is provided. The LED lamp includes an LED kernel having at least one red LED and a plurality of blue LEDs. The LED kernel is configured to emit primary light. The LED lamp further includes a converter comprising at least one phosphor for converting at least some of the primary light to secondary light. The LED lamp exhibits a color rendering index (CRI) of greater than or equal to about 90. The LED lamp also exhibits a difference in correlated color temperature (DCCT) of less than or equal to about 300K during lamp warm-up (i.e., from initial powering to 20 minutes of operation).

According to another aspect of the present disclosure, the converter includes a red phosphor in an amount ranging from greater than 0 to about 10 weight % of a total phosphor content of the converter.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An LED lamp, comprising:
an LED kernel comprising at least one red LED and a plurality of blue LEDs, said LED kernel configured to emit primary light;
a converter comprising at least one phosphor for converting at least some of said primary light to secondary light;
wherein said lamp exhibits a color rendering index of greater than or equal to about 90; and
said lamp exhibits a difference in correlated color temperature (DCCT) of less than or equal to about 300K during lamp warm-up.

2. The LED lamp of claim 1, wherein said lamp exhibits a DCCT during lamp warm-up of less than or equal to about 200K.

3. The LED lamp of claim 2, wherein said lamp exhibits a DCCT during lamp warm-up of less than or equal to about 150K.

4. The LED lamp of claim 1, wherein said primary light has a ratio of red light power to blue light power ranging from about 0.025 to about 0.2.

5. The LED lamp of claim 4, wherein said ratio of red light power to blue light power ranges from about 0.05 to about 0.1.

6. The LED lamp of claim 1, wherein a ratio of red to blue LEDs in said LED kernel ranges from about 1:4 to about 1:10.

7. The LED lamp of claim 1, wherein said ratio of red to blue LEDs in said LED kernel ranges from about 1:5 to about 1:8.

8. The LED lamp of claim 1, wherein said converter contains a red phosphor in an amount ranging from greater than 0 to about 10 weight % of a total phosphor content of said converter.

9. The LED lamp of claim 8, where said red phosphor is present in an amount ranging from about 3 to about 7 weight % of the total phosphor content of said converter.

10. The LED lamp of claim 1, wherein said lamp exhibits greater than or equal to about 80% lumen maintenance during lamp warm-up.

11. The LED lamp of claim 1, wherein said lamp exhibits greater than or equal to about 95% lumen maintenance during lamp warm-up.

12. The LED lamp of claim 8, wherein said lamp exhibits a DCCT of less than or equal to about 300K during lamp warm-up.

13. The LED lamp of claim 8, wherein said lamp exhibits a DCCT of less than or equal to about 150K during lamp warm-up.

14. The LED lamp of claim 8, wherein said primary light has a ratio of red light power to blue light power ranging from about 0.025 to about 0.2.

15. The LED lamp of claim 8, wherein said ratio of red light power to blue light power ranges from about 0.05 to about 0.1.

16. The LED lamp of claim 8, wherein a ratio of red to blue LEDs in said LED kernel ranges from about 1:4 to about 1:10.

17. The LED lamp of claim 8, wherein said ratio of red to blue LEDs in said LED kernel ranges from about 1:5 to about 1:8.

18. The LED lamp of claim 1, wherein a ratio of red to blue LEDs in said LED kernel ranges from about 1:5 to about 1:8 and said converter contains a red phosphor in an amount ranging from about 3 to about 8 weight % of a total phosphor content of said converter.

19. The LED lamp of claim 1, wherein a ratio of red to blue LEDs in said LED kernel ranges from about 1:5 to about 1:7 and said converter contains a red phosphor in an amount ranging from about 4 to about 7 weight % of a total phosphor content of said converter.

20. The LED lamp of claim 1, wherein a ratio of red to blue LEDs in said LED kernel ranges is about 1:6 and said converter contains a red phosphor in an amount ranging from about 5 to about 6.5 weight % of a total phosphor content of said converter.

21. The LED lamp of claim 1, wherein said blue and red LEDs are powered by a same electrical circuit.

22. The LED lamp of claim 8, wherein said blue and red LEDs are powered by a same electrical circuit.
